(19) United States
(12) Patent Application Publication
(10) Pub. No.: US 2022/0049955 A1
(43) Pub. Date: Feb. 17, 2022

(54) METHOD FOR ACQUIRING CONTACT ANGLE OF ANGULAR CONTACT BALL BEARING AND METHOD FOR MANUFACTURING WHEEL BEARING DEVICE

(71) Applicant: JTEKT CORPORATION, Kariya-shi, Aichi (JP)

(72) Inventors: Liming LOU, Kashihara-shi (JP); Yuuki TAKEDA, Kashiba-shi (JP); Naoki SAWADA, Kashihara-shi (JP); Kei SUMIMOTO, Yao-shi (JP)

(73) Assignee: JTEKT CORPORATION, Kariya-shi, Aichi (JP)

(21) Appl. No.: 17/431,094

(22) PCT Filed: Mar. 17, 2020
(86) PCT No.: PCT/JP2020/011675

§ 371 Date: Aug. 13, 2021

(30) Foreign Application Priority Data
Mar. 25, 2019 (JP) 2019-056836
Nov. 21, 2019 (JP) 2019-210357

(51) Int. Cl. G01B 21/22; F16C 19/18; F16C 43/04

(52) U.S. Cl. CPC G01B 21/22; F16C 19/181; B60B 27/0005; F16C 2233/00; F16C 43/04

(57) ABSTRACT

A method for acquiring a contact angle of an angular contact ball bearing includes: a first detection step of detecting a number of rotation of a first bearing ring of an angular contact ball bearing; a second detection step of externally detecting deformation of a second bearing ring associated with orbital rotation of a ball of the angular contact ball bearing; and a calculation step of obtaining a contact angle α of the ball using a detection result of the first detection step, a detection result of the second detection step, and specification data pertaining to the ball.

### TECHNICAL FIELD

The present disclosure relates to a method for acquiring a contact angle of an angular contact ball bearing and a method for manufacturing a wheel bearing device.

### BACKGROUND ART

In a vehicle such as an automobile, a wheel bearing device (hub unit) is used to support a wheel (see, for example, Patent Literature 1). As illustrated in FIG. 15, a wheel bearing device 110 includes an outer ring 111, an inner shaft 112, and balls 113 arranged in double rows between the outer ring 111 and the inner shaft 112. The balls 113 in respective rows contact raceways 111b, 116e, and 117e formed in the outer ring 111 and the inner shaft 112 at a predetermined contact angle α. Therefore, the wheel bearing device 110 is an angular contact ball bearing in which the balls 13 obliquely contact the raceways 111b, 116e, and 117e.

The inner shaft 112 includes a shaft member 16 having formed therein the raceway 116e which is a raceway on an axially one side, and an inner-ring member 117 having formed therein the raceway 117e which is a raceway on an axially other side. The inner-ring member 117 is engaged with a small-diameter part 116c formed in the shaft member 116, and is fixed to the small-diameter part 116c by caulking an end part 116d of the shaft member 116 on the axially other side outward in the radial direction.

### CITATION LIST

### Patent Literature

Patent Literature 1: Japanese Unexamined Patent Publication No. 2017-1524

### SUMMARY OF INVENTION

A method for acquiring a contact angle of an angular contact ball bearing according to the present disclosure includes: a first detection step of detecting a number of rotation of a first bearing ring of an angular contact ball bearing; a second detection step of externally detecting deformation of a second bearing ring associated with orbital rotation of a ball of the angular contact ball bearing; and a calculation step of obtaining a contact angle of the ball using a detection result of the first detection step, a detection result of the second detection step, and specification data pertaining to the ball.

A method for acquiring a contact angle of an angular contact ball bearing according to the present disclosure is a method for acquiring a contact angle of an angular contact ball bearing that includes an outer ring, an inner ring disposed inside of the outer ring in a radial direction, and a plurality of balls placed between the outer ring and the inner ring, the method including: an estimation step of obtaining, using a number of rotation of the inner ring, specification data pertaining to the balls, and a design value of a contact angle of each of the balls, an estimated value of a frequency of periodic displacement of the outer ring associated with orbital rotation of the balls when the inner ring is rotated; a detection step of externally detecting the displacement of the outer ring by a sensor with the inner ring being rotated; an analysis step of performing a frequency analysis on a detection result of the detection step; a determination step of determining the frequency of the displacement of the outer ring from an analysis result of the analysis step on the basis of the estimated value obtained in the estimation step; and a calculation step of obtaining the contact angle of each of the balls using the frequency determined in the determination step, the number of rotation of the inner ring, and the specification data pertaining to the balls.

The present disclosure provides a method for manufacturing a wheel bearing device that is an angular contact ball bearing, the wheel bearing device including an outer ring having a first outer raceway and a second outer raceway formed in an inner peripheral surface on an axially one side and an axially other side, an inner shaft including a shaft member that has a first inner raceway formed in an outer peripheral surface, and an inner-ring member that is engaged with a small-diameter part of the shaft member on the axially other side, the inner-ring member having a second inner raceway formed in an outer peripheral surface, a plurality of first balls that is in contact with the first outer raceway and the first inner raceway at a contact angle, and a plurality of second balls that is in contact with the second outer raceway and the second inner raceway at the contact angle, the method including; an assembly step including a step of placing the plurality of first balls on the first inner raceway, a step of assembling the shaft member and the outer ring together such that the first outer raceway is placed on the plurality of first balls, a step of placing the plurality of second balls on the second outer raceway and engaging the inner-ring member with the small-diameter part such that the second inner raceway of the inner-ring member is placed on the plurality of second balls, and a fixing step of fixing the inner-ring member to the shaft member by plastically deforming an end part of the shaft member on the axially other side outward in a radial direction and caulking the deformed end part; and a contact angle acquisition step of obtaining the contact angle in a state where the wheel bearing device is assembled through the assembly step or in parallel with the fixing step, wherein the method for acquiring a contact angle of an angular contact ball bearing described above is used as a method for obtaining the contact angle in the contact angle acquisition step.

### BRIEF DESCRIPTION OF DRAWINGS

FIG. 1 is a cross-sectional view of an angular contact ball bearing used for a method for acquiring a contact angle according to a first embodiment of a first invention.

FIG. 2 is an explanatory diagram illustrating a deformation detection sensor.

FIG. 3 is a graph indicating output results of a rotation detection sensor and the deformation detection sensor.

FIG. 4 is a cross-sectional view illustrating an example of a manufacturing device for manufacturing a wheel bearing device.

FIG. 5 is an explanatory diagram illustrating a deformation detection sensor used for a method for acquiring a contact angle according to a second embodiment of the first invention.

FIG. 6 is a cross-sectional view of an angular contact ball bearing used for a method for acquiring a contact angle according to a first embodiment of a second invention.

FIG. 7 is an explanatory diagram illustrating a displacement detection sensor.

FIG. 8 is a graph indicating a detection result of the displacement detection sensor.

FIG. 9 is a graph obtained by performing frequency analysis on a detection result of the displacement detection sensor.

FIG. 10 is an explanatory diagram illustrating a displacement detection sensor used for a method for acquiring a contact angle according to a second embodiment of the second invention.

FIG. 11 is a cross-sectional view illustrating another example of the manufacturing device for manufacturing a wheel bearing device.

FIG. 12 is a cross-sectional view of the manufacturing device illustrated in FIG. 11.

FIG. 13 is a cross-sectional view of the manufacturing device illustrated in FIG. 11.

FIG. 14 is a cross-sectional view of the manufacturing device illustrated in FIG. 11.

FIG. 15 is a cross-sectional view of a wheel bearing device which is an angular contact ball bearing.

### DESCRIPTION OF EMBODIMENTS

### Problems to be Solved by Invention of Present Disclosure

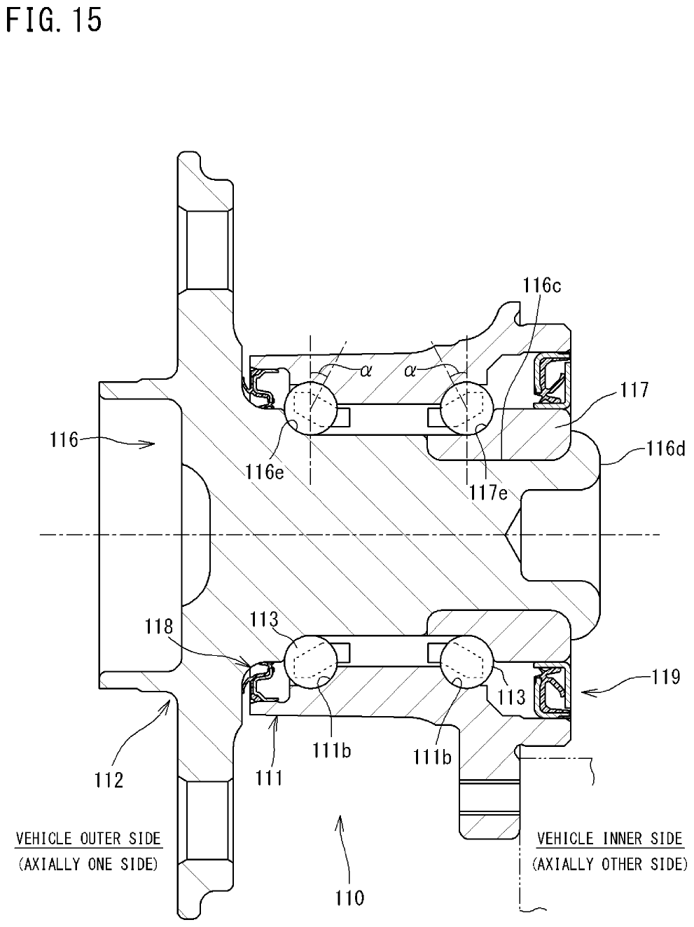

When the wheel bearing device 110 illustrated in FIG. 15 is assembled, the inner-ring member 117 engaged with the small-diameter part 116c is pressed toward the axially one side by caulking the end part 116d of the shaft member 116 on the axially other side. The contact angles α of the balls 113 with respect to the raceways 111b, 116e, and 117e vary due to the pressing load. The contact angles α of the balls 113 affect rigidity (preload) and rotational torque of the wheel bearing device 110. Therefore, it is required to assemble the wheel bearing device 110 so that the contact angles α have an appropriate value (design value) determined by design.

However, in the assembled wheel bearing device 110, the contact portions between the raceways 111b, 116e, and 117e and the balls 13 are located between the outer ring 111 and the inner shaft 112, so that it is difficult to directly measure the contact angles α. When both axial end portions between the outer ring 111 and the inner shaft 112 are covered with sealing members 118 and 119, it is substantially impossible to measure the contact angles α. Therefore, at present, the contact angles α are set to a desired value by controlling a load applied for caulking the end part 116d of the shaft member 116 during a step of assembling the wheel bearing device 110. However, this method may increase a variation in the contact angles α, which may cause a variation in the quality of products.

An object of the present disclosure is to provide a method with which it is possible to acquire a contact angle of a ball with respect to a raceway even in an angular contact ball bearing in an assembled state, and a method for manufacturing a wheel bearing device using the method.

### Advantageous Effects of Invention of Present Disclosure

Even in an angular contact ball bearing in the assembled state, the contact angle of a ball with respect to a raceway can be acquired.

### OVERVIEW OF EMBODIMENTS OF INVENTION ACCORDING TO PRESENT DISCLOSURE

An overview of embodiments of the invention according to the present disclosure will be listed and described below.

(First Invention)

(1) A method for acquiring a contact angle of an angular contact ball bearing according to the present disclosure includes: a first detection step of detecting a number of rotation of a first bearing ring of an angular contact ball bearing; a second detection step of externally detecting deformation of a second bearing ring associated with orbital rotation of a ball of the angular contact ball bearing; and a calculation step of obtaining a contact angle of the ball using a detection result of the first detection step, a detection result of the second detection step, and specification data pertaining to the ball.

According to the method for acquiring a contact angle described above, the deformation of the bearing ring associated with the orbital rotation of the ball of the angular contact ball bearing is detected from the outside, and the contact angle of the ball is obtained using the detection result. Therefore, the contact angle of the ball can be obtained even in a state where the angular contact ball bearing is assembled. The obtained contact angle can be used for quality control or the like of the angular contact ball bearing.

(2) Preferably, the deformation of the second bearing ring is detected by a strain gauge in the second detection step.

With this configuration, the deformation of the second bearing ring can be detected from the outside.

(3) Preferably, the deformation of the second bearing ring is detected by a displacement sensor in the second detection step.

With this configuration, the deformation of the second bearing ring can be detected from the outside.

(4) Preferably, a detection position of the deformation of the second bearing ring is located within a region between a first point and a second point on a circumferential surface of the second bearing ring opposite to a surface in which the raceway of the ball is formed,

the first point being on a straight line that is perpendicular to an axis of the angular contact ball bearing and that passes through a center of the ball, and

the second point being on a straight line that passes through a contact point between a raceway of the second bearing ring and the ball and the center of the ball.

With this configuration, it is possible to efficiently detect the deformation of the bearing ring by setting a region where the deformation is great as a target.

(5) Preferably, the angular contact ball bearing is a wheel bearing device that includes: an outer ring having a double-row outer raceway; an inner shaft having a double-row inner raceway; and a plurality of balls that is placed between the outer raceway and the inner raceway and that is in contact with the respective raceways at a contact angle, the inner shaft including a shaft member that has an inner raceway on an axially one side and an inner-ring member that has an inner raceway on an axially other side and that is caulked and fixed to the shaft member.

(6) Preferably, the first detection step, the second detection step, and the calculation step are performed in parallel with an assembly step of the wheel bearing device.

With this method, the wheel bearing device can be assembled so as to obtain an appropriate contact angle.

(7) It is preferable that: the first detection step includes a step of detecting a number of rotation of the first bearing ring of the angular contact ball bearing, and an estimation step of obtaining, using the detected number of rotation of the first bearing ring, the specification data pertaining to the ball, and a design value of the contact angle of the ball, an estimated value of a frequency of periodic displacement of the second bearing ring associated with the orbital rotation of the ball when the first bearing ring is rotated; in the second detection step, displacement of the second bearing ring is externally detected by a sensor as the deformation of the second bearing ring with the first bearing ring being rotated; and the calculation step includes an analysis step of performing a frequency analysis on a detection result of the second detection step, a determination step of determining the frequency of the displacement of the second bearing ring from an analysis result of the analysis step on the basis of the estimated value obtained in the estimation step, and a calculation step of obtaining the contact angle of the ball using the frequency determined in the determination step, the number of rotation of the first bearing ring, and the specification data pertaining to the ball.

(8) Preferably, the method for acquiring a contact angle of an angular contact ball bearing further includes an assessment step of assessing whether or not the contact angle obtained in the calculation step falls within an acceptable error range of the design value of the contact angle.

(Second Invention)

(9) The present disclosure provides a method for acquiring a contact angle of an angular contact ball bearing that includes an outer ring, an inner ring disposed inside of the outer ring in a radial direction, and a plurality of balls placed between the outer ring and the inner ring, the method including: an estimation step of obtaining, using a number of rotation of the inner ring, specification data pertaining to the balls, and a design value of a contact angle of each of the balls, an estimated value of a frequency of periodic displacement of the outer ring associated with orbital rotation of the balls when the inner ring is rotated; a detection step of externally detecting the displacement of the outer ring by a sensor with the inner ring being rotated; an analysis step of performing a frequency analysis on a detection result of the detection step; a determination step of determining the frequency of the displacement of the outer ring from an analysis result of the analysis step on the basis of the estimated value obtained in the estimation step; and a calculation step of obtaining the contact angle of each of the balls using the frequency determined in the determination step, the number of rotation of the inner ring, and the specification data pertaining to the balls.

With this method for acquiring a contact angle, an estimated value of a frequency of displacement of the outer ring associated with orbital rotation of the balls of the angular contact ball bearing is obtained. The displacement is detected from the outside by a sensor, and the detection result is subjected to frequency analysis. The frequency of the displacement is determined from the result of the frequency analysis on the basis of the estimated value of the frequency of the displacement, and the contact angle of each of the balls is obtained using the determined frequency and the like. Thus, the contact angles of the balls can be obtained even in a state where the angular contact ball bearing is assembled. The obtained contact angles can be used for quality control or the like of the angular contact ball bearing.

The sensor may detect displacement, noise, and the like generated by a factor different from the factor of the displacement of the outer ring associated with the orbital rotation of the ball. Therefore, it may be difficult to directly determine the frequency of the displacement of the outer ring associated with the orbital rotation of the ball from the detection result of the sensor. In the present disclosure, an estimated value of the frequency to be determined is obtained using the design value of the contact angle of the ball, and the frequency of the displacement of the outer ring associated with the orbital rotation of the ball is determined from the frequency analysis of the detection result of the sensor on the basis of the comparison with the estimated value. Therefore, the contact angle of the ball can be obtained more accurately.

(10) Preferably, the sensor is a non-contact sensor. With this configuration, it is not necessary to directly mount the sensor on the outer ring or to incorporate the sensor. Therefore, the displacement of the outer ring associated with the orbital rotation of the ball can be quickly detected with a simple configuration.

(11) Preferably, the sensor is a contact sensor, and is detachably mounted to the outer ring. With this configuration, it is not necessary to incorporate the sensor in the outer ring, and the sensor may be attached to the outer ring when the contact angle of the ball is obtained.

(12) Preferably, a region where the sensor detects the displacement of the outer ring at least partially overlaps a region between a first point and a second point on an outer surface of the outer ring, the first point being on a straight line that is perpendicular to a central axis of the angular contact ball bearing and that passes through a center of the ball, and the second point being on a straight line that passes through a contact point between a raceway of the outer ring and the ball and the center of the ball. With this configuration, it is possible to efficiently detect the displacement of the outer ring due to rolling of the ball by setting a region where the displacement is great as a target.

(13) Preferably, the method for acquiring a contact angle further includes an assessment step of assessing whether or not the contact angle obtained in the calculation step falls within an acceptable error range of the design value of the contact angle. With this configuration, it is possible to suppress variations in product quality of the wheel bearing device.

(Method for Manufacturing Wheel Bearing Device as Angular Contact Ball Bearing)

(14) The present disclosure provides a method for manufacturing a wheel bearing device that is an angular contact ball bearing, the wheel bearing device including an outer ring having a first outer raceway and a second outer raceway formed in an inner peripheral surface on an axially one side and an axially other side, an inner shaft including a shaft member that has a first inner raceway formed in an outer peripheral surface, and an inner-ring member that is engaged with a small-diameter part of the shaft member on the axially other side, the inner-ring member having a second inner raceway formed in an outer peripheral surface, a plurality of first balls that is in contact with the first outer raceway and the first inner raceway at a contact angle, and a plurality of second balls that is in contact with the second outer raceway and the second inner raceway at the contact angle, the method including:

an assembly step including a step of placing the plurality of first balls on the first inner raceway, a step of assembling the shaft member and the outer ring together such that the first outer raceway is placed on the plurality of first balls, a step of placing the plurality of second balls on the second outer raceway and engaging the inner-ring member with the small-diameter part such that the second inner raceway of the inner-ring member is placed on the plurality of second balls, and a fixing step of fixing the inner-ring member to the shaft member by plastically deforming an end part of the shaft member on the axially other side outward in a radial direction and caulking the deformed end part; and

a contact angle acquisition step of obtaining the contact angle in a state where the wheel bearing device is assembled through the assembly step or in parallel with the fixing step,

wherein the method for acquiring a contact angle of an angular contact ball bearing according to any one of (1) to (13) described above is used as a method for obtaining the contact angle in the contact angle acquisition step.

### DETAILS OF EMBODIMENTS OF INVENTION ACCORDING TO PRESENT DISCLOSURE

Embodiments of the invention according to the present disclosure will now be described.

(First Invention)

### First Embodiment of First Invention

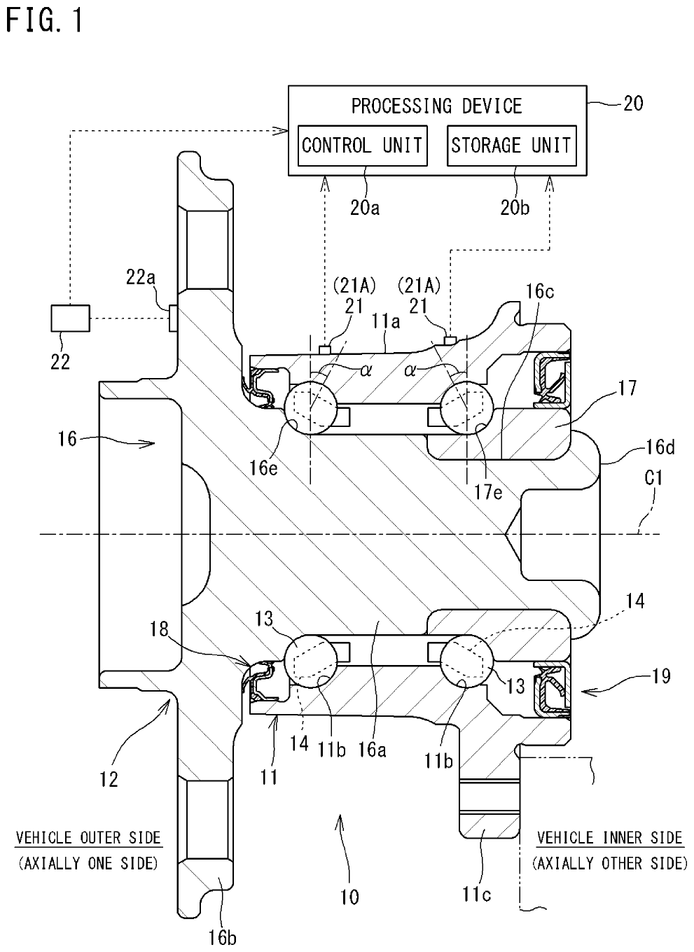

FIG. 1 is a cross-sectional view of an angular contact ball bearing used for a method for acquiring a contact angle according to a first embodiment. The angular contact ball bearing according to the present embodiment is a wheel bearing device (hub unit) 10 used for a vehicle such as an automobile.

The wheel bearing device 10 supports a wheel in a rotatable manner with respect to a suspension device provided to a body of the vehicle. The wheel bearing device 10 includes an outer ring 11, an inner shaft 12, balls 13, and cages 14. In the following description, a direction parallel to a central axis C1 of the wheel bearing device 10 (horizontal direction in FIG. 1) is referred to as an axial direction. In a state where the wheel bearing device 10 is mounted on the body of the vehicle, the left side in FIG. 1 which is the vehicle outer side is referred to as an axially one side, and the right side in FIG. 1 which is the vehicle inner side is referred to as an axially other side.

In the present disclosure, the central axis of the inner shaft 12 and the central axis of the outer ring 11 coincide with each other, and they are set as the central axis C1 of the wheel bearing device 10. A direction perpendicular to the central axis C1 is a radial direction.

The outer ring 11 and the inner shaft 12 are located concentrically. In the present embodiment, the inner shaft 12 is rotatable about the central axis C1 with respect to the outer ring 11. The wheel bearing device 10 rotatably supports the inner shaft 12 on which a wheel or a brake disk (not illustrated) is fixed to a flange part 16b with respect to the vehicle body.

The outer ring 11 is made of carbon steel for machine structural use, or the like. The outer ring 11 is formed into a cylindrical shape, and has a flange 11c on an outer peripheral surface 11a. The flange 11c is fixed to the suspension device, which is mounted on the vehicle body, with a bolt. A double-row outer raceway 11b is formed in the inner peripheral surface of the outer ring 11.

The inner shaft 12 is made of carbon steel for machine structural use, or the like. The inner shaft 12 constitutes an inner ring of the angular ball bearing. The inner shaft 12 includes a shaft member 16 and an inner-ring member 17.

The shaft member 16 has a main body part 16a extending along the axial direction and a flange part 16b protruding outward from the main body part 16a in the radial direction. The main body part 16a and the flange part 16b are integrally formed. The flange part 16b is provided on the axially one side of the main body part 16a. The flange part 16b is mounted with a wheel and a brake disk (not shown).

The inner-ring member 17 is annular, and fixed to an end part of the shaft member 16 on the axially other side. Specifically, the shaft member 16 has a small-diameter part 16c having an outer diameter smaller than that of other part of the main body part 16a on the axially other side. The inner-ring member 17 is engaged with the small-diameter part 16c. The inner-ring member 17 is fixed to the shaft member 16 by plastically deforming an end part 16d of the shaft member 16 on the axially other side outward in the radial direction and caulking the deformed end part 16d.

An inner raceway 16e is formed in the outer peripheral surface of the main body part 16a of the shaft member 16. The inner raceway 16e faces the outer raceway 11b located on the axially one side. An inner raceway 17e is formed in the outer peripheral surface of the inner-ring member 17. The inner raceway 17e faces the outer raceway 11b located on the axially other side.

Multiple first balls 13 are disposed between the first outer raceway 11b and the first inner raceway 16e on the axially one side. Multiple second balls 13 are disposed between the second outer raceway 11b and the second inner raceway 17e on the axially other side. The multiple balls 13 in each row are retained by cages 14 at intervals in the circumferential direction. Each of the outer raceway 11b and the inner raceways 16e and 17e has a cross-section with a concave arc shape. The first balls 13 are in point contact with each of the first outer raceway 11b and the first inner raceway 16e at a contact angle α. The second balls 13 are in point contact with each of the second outer raceway 11b and the second inner raceway 17e at the contact angle α. Thus, the wheel bearing device 10 is configured as a double-row angular ball bearing, and the outer ring 11 and the inner shaft 12 constitute respective bearing rings.

Sealing members 18 and 19 are attached between both end parts of the outer ring 11 in the axial direction and the inner shaft 12, more specifically, between the end part of the outer ring 11 on the axially one side and the main body part 16a and between the end part of the outer ring 11 on the axially other side and the inner-ring member 17, respectively. The sealing members 18 and 19 function to prevent intrusion of foreign matters such as muddy water into an annular space formed between the outer ring 11 and the inner shaft 12 and sealing the annular space so as to prevent a leakage of lubricant in the annular space.

In the wheel bearing device 10 having the above configuration, the contact angles α of the balls 13 with respect to the outer raceway 11b and the inner raceways 16e and 17e affect the rigidity and rotational torque of the wheel bearing device 10. Therefore, it is required to set the contact angles α to an appropriate value determined by design. However, it is difficult to directly measure the contact angle α of each ball 13 arranged inside the wheel bearing device 10. Therefore, the wheel bearing device 10 is assembled so that the contact angles α have an appropriate value by controlling a load applied for caulking and fixing the inner-ring member 17 to the shaft member 16.

However, each component constituting the wheel bearing device 10 has a dimensional error or the like. Therefore, the contact angles α of the balls 13 are likely to vary only by controlling the load applied for caulking and fixing. As a result, it is difficult to maintain a constant level of quality of the wheel bearing device 10 as a product.

In view of this, the present embodiment aims to improve the quality of the wheel bearing device 10 by enabling acquisition of the contact angle α of each ball 13 even in the assembled wheel bearing device 10.

[Method for Acquiring Contact Angle]

A specific method for acquiring the contact angle will be described below.

As illustrated in FIG. 1, in the present embodiment, sensors 22 and 21 detect the number of rotation of the inner shaft 12 and the deformation of the outer ring 11 when the inner shaft 12 is rotated, and a processing device 20 obtains the contact angle α of the ball 13 using the detection results of the sensors 22 and 21. That is, the method for acquiring the contact angle according to the present embodiment includes: a first detection step of detecting the number of rotation of the inner shaft 12; a second detection step of detecting deformation of the outer ring 11; and a calculation step of obtaining the contact angle α of the ball 13 using the detection results of the first detection step and the second detection step.

The processing device 20 includes, for example, a computer including a control unit 20a including a CPU and the like and a storage unit 20b including a storage such as an HDD, a volatile memory, and the like. The control unit 20a executes a computer program read from the storage unit 20b to perform processing of calculating the contact angle α of the ball 13.

As information for obtaining the contact angle α, the processing device 20 stores Equations (1) and (2) to be described later and parameters included in Equations (1) and (2) in the storage unit 20b.

Equation (1) is for obtaining the orbital number of rotation f of the ball 13.

$$\begin{matrix}[ Equation 1 ] & \\ f = \frac{1}{2} ( 1 - \frac{{D}_{w}}{{D}_{pw}} cos α ) {f}_{r} & ( 1 )\end{matrix}$$

In Equation 1, Dw is the diameter of the ball 13, Dpw is the pitch circle diameter of the ball 13, α is the contact angle, and fr is the number of rotation of the inner shaft 12 in a predetermined time. The units of Dw and Dew are the same. The units off and fr are the same.

The orbital number of rotation f of the ball 13 can be expressed by Equation (2) below using the number n of the balls 13 and the number of times (the number of passages of the balls 13) p the balls 13 pass through a specific position of the outer ring 11 in the circumferential direction in a predetermined time (unit time).

f=p/n (2)

In Equations (1) and (2) above, the diameter Dw, the pitch circle diameter Dpw, and the number n, which are specification data pertaining to the balls 13, are known values and stored in the storage unit 20b. The number of rotation fr of the inner shaft 12 and the number of passages p of the balls 13 are obtained by the processing device 20 from the detection results of the sensors 22 and 21, respectively.

The number of rotation fr of the inner shaft 12 is obtained using the detection result of the rotation detection sensor 22. As the rotation detection sensor 22, an optical rotation detection sensor is used, for example. The optical rotation detection sensor irradiates the flange part 16b of the inner shaft 12 with light, and measures reflected light from a reflection plate 22a provided on the flange part 16b. The detection result of the rotation detection sensor 22 is transmitted to the processing device 20. The position detected by the rotation detection sensor 22 is not particularly limited as long as it periodically moves with the rotation of the inner shaft 12.

The number of passages p of the balls 13 is obtained using the detection result of the deformation detection sensor 21. The deformation detection sensor 21 is provided on the outer peripheral surface 11a of the outer ring 11, and externally detects deformation of the outer ring 11 associated with the orbital rotation of the balls 13 on the outer raceway 11b. Specifically, in the present embodiment, a strain gauge 21A is used as the deformation detection sensor 21. The strain of the outer peripheral surface 11a of the outer ring 11 is measured by the strain gauge 21A. The detection result of the strain gauge 21A is transmitted to the processing device 20.

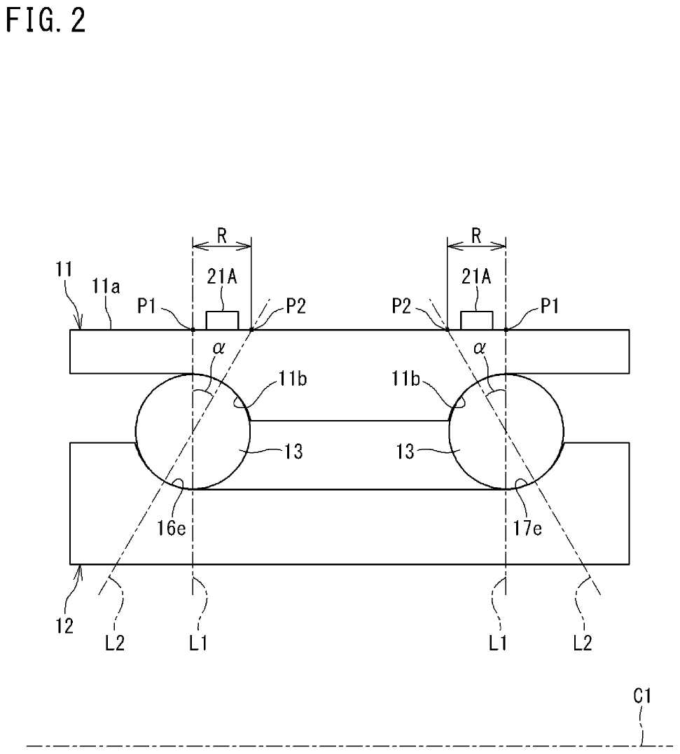

FIG. 2 is an explanatory diagram illustrating the deformation detection sensor 21.

The strain gauge 21A is provided to detect deformation of the outer ring 11 within a region R illustrated in FIG. 2. The region R is located between a first point P1 and a second point P2 on the outer peripheral surface 11a of the outer ring 11. The first point P1 is located on a straight line L1 that is perpendicular to the central axis C1 of the wheel bearing device 10 and passes through the center of the ball 13. The second point P2 is located on a straight line (straight line forming the contact angle α) L2 passing through the contact point between the outer raceway 11b and the ball 13 and the center of the ball 13. The region R is a portion where the outer ring 11 is relatively largely deformed by the rolling of the ball 13 on the outer raceway 11b. The strain gauge 21A may be provided to detect deformation of the outer ring 11 in the entire region R, or may be provided to detect deformation in a part of the region R.

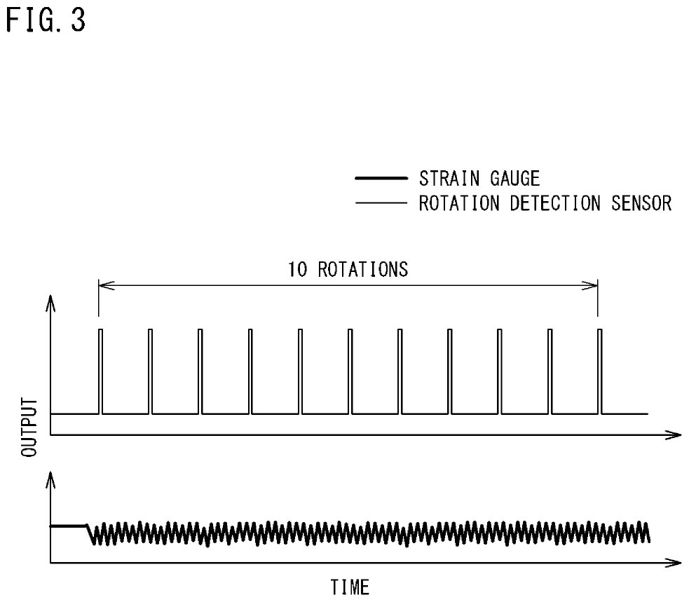

FIG. 3 is a graph illustrating output results of the rotation detection sensor 22 and the deformation detection sensor 21.

The horizontal axis of the graph represents time, and the vertical axis represents the output value (voltage value) of the signal of each of the sensors 21 and 22. The rotation detection sensor 22 outputs a signal every time the inner shaft 12 makes one rotation. FIG. 3 (upper graph) illustrates outputs of 10 rotations of the inner shaft 12.

The strain gauge 21A outputs a larger signal as the deformation of the outer ring 11 is larger. When the ball 13 rolls on the outer raceway 11b and passes immediately below the strain gauge 21A, the outer ring 11 is pressed radially outward by the ball 13. Therefore, the elastic deformation of the outer ring 11 at the portion to which the strain gauge 21A is attached increases. In addition, after the ball 13 passes immediately below the strain gauge 21A, the outer ring 11 is not pressed radially outward by the ball 13. Therefore, the elastic deformation of the outer ring 11 is eliminated. The strain gauge 21A reflects such deformation of the outer ring 11 and outputs a signal that fluctuates vertically. Therefore, it can be considered that each of the peak parts of the graph that fluctuates vertically is the timing at which the ball 13 passes immediately below the strain gauge 21A.

The processing device 20 obtains the orbital number of rotation f of the ball 13 by dividing the number of passages p of the balls 13 by the number n of the balls 13 using Equation (2). Then, the processing device 20 obtains the contact angle α of the ball 13 from the orbital number of rotation f of the ball 13, the number of rotation fr detected by the rotation detection sensor 22, and the specification data Dw and Dpw of the ball 13 using Equation (1).

If the contact angle α of the ball 13 thus obtained falls within an acceptable error range of a predetermined design value, the wheel bearing device 10 is considered to be a product that satisfies the predetermined quality. If the contact angle α is smaller than a predetermined value, the contact angle α is increased by additionally performing a caulking process on the shaft member 16 of the inner shaft 12. Due to such process, predetermined quality can also be obtained.

The strain gauge 21A is not required to accurately detect strain, and it is only sufficient that the strain gauge 21A can detect vertical fluctuations in output as illustrated in FIG. 3. Therefore, it is not necessary to perform a pretreatment for smoothing the portion where the strain gauge 21A is to be attached on the outer peripheral surface 11a of the outer ring 11. The outer ring 11 is usually formed by casting, and a casting surface remains on the outer peripheral surface thereof. It is not necessary to perform a pretreatment for shaving the casting surface in order to attach the strain gauge 21A. It is possible to acquire the contact angle α in an actual product in a state where the outer peripheral surface has a casting surface.

The method for acquiring the contact angle α as described above is not limited to be performed after the assembly of the wheel bearing device 10, and can be performed in parallel with the assembly step (manufacturing step) of the wheel bearing device 10.

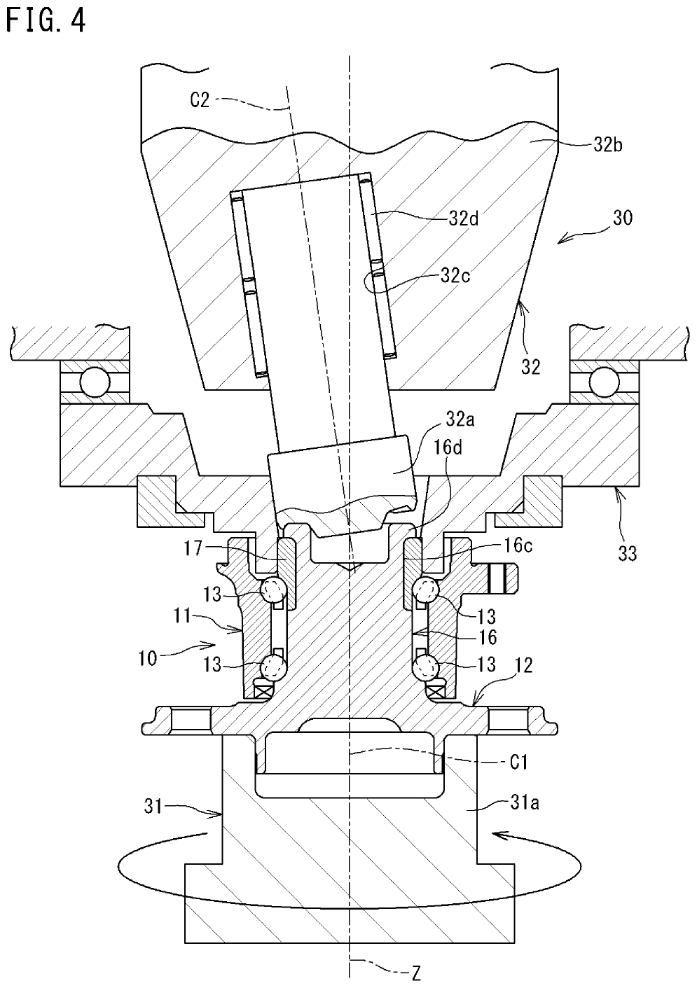

FIG. 4 is a cross-sectional view illustrating an example of a manufacturing device for manufacturing the wheel bearing device 10.

The manufacturing device 30 is for fixing the inner-ring member 17 to the small-diameter part 16c by caulking the end part 16d of the shaft member 16 of the inner shaft 12 on the axially other side.

The manufacturing device 30 includes a rotation apparatus 31, a caulking apparatus 32, and a restraint apparatus 33. The wheel bearing device 10 is mounted on a rotary member 31a of the rotation apparatus 31 such that the axially other side which is to be subjected to the caulking process is directed upward with the central axis C1 of the inner shaft 12 defined as the vertical direction. The rotary member 31a is rotated about a reference axis Z in the vertical direction by an electric motor (not illustrated), and the inner shaft 12 is also simultaneously rotated. The sensors 21 and 22 used to acquire the contact angle α are attached to the wheel bearing device 10 mounted on the rotary member 31a.

The caulking apparatus 32 includes a punch 32a and a fixed spindle 32b.

The fixed spindle 32b is a columnar member centered on the reference axis (reference line) Z of the manufacturing device 30, and is fixed to a lifting frame (not illustrated) so as to be movable in the vertical direction. A hole 32c opened downward is formed in the fixed spindle 32b. A central axis (center line) C2 of the hole 32c is inclined at a predetermined angle with respect to the reference axis Z.

The punch 32a is formed in a shaft shape, and is provided in a rotatable manner inside the hole 32c via a bearing part 32d. The punch 32a is pressed against the end part 16d on the axially other side of the shaft member 16 which is rotating by the rotation apparatus 31 by lowering the fixed spindle 32b, and caulks the end part 16d.

The contact angle α of the ball 13 is acquired in parallel with the assembly step of the wheel bearing device 10 as described above. As a result, caulking process is performed until the contact angle α reaches an appropriate value, whereby it is possible to suppress variations in quality of the wheel bearing device 10. The acquisition of the contact angle α performed in parallel with the assembly step of the wheel bearing device 10 includes acquiring the contact angle α simultaneously with the caulking process of the shaft member 16 and alternately performing acquisition of the contact angle α of the ball 13 and the caulking process of the shaft member 16. In the former case, while the shaft member 16 is caulked, the contact angle α of the ball 13 is simultaneously acquired and checked, and when the contact angle α reaches an appropriate value, the caulking process is terminated. In the latter case, the caulking process is intermittently performed while the contact angle α is checked. Specifically, for example, after the shaft member 16 is caulked halfway, the contact angle α of the ball 13 is temporarily acquired and checked, and then, the caulking process is started again.

### Second Embodiment of First Invention

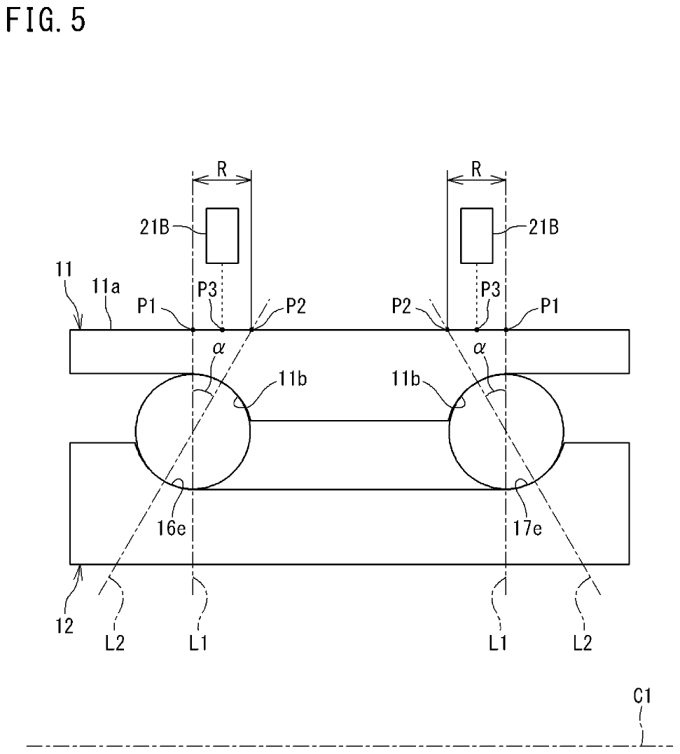

FIG. 5 is an explanatory diagram illustrating a deformation detection sensor used for a method for acquiring a contact angle according to a second embodiment.

In the abovementioned embodiment (see FIG. 2), the strain gauge 21A is used as the deformation detection sensor 21. In the second embodiment, a displacement sensor 21B is used as the deformation detection sensor 21. The displacement sensor 21B is a non-contact sensor such as a laser displacement sensor. The displacement sensor 21B detects the displacement of the outer ring 11 in the radial direction at a specific point P3 in the region R. Note that the displacement sensor 21B may be a contact sensor.

When the ball 13 passes immediately below the point P3, the outer peripheral surface 11a of the outer ring 11 is displaced so as to slightly expand outward in the radial direction. After the ball 13 passes immediately below the point P3, the outer peripheral surface 11a of the outer ring 11 is displaced so as to shrink inward in the radial direction. The displacement sensor 21B detects such displacement of the outer peripheral surface 11a of the outer ring 11 in the radial direction. Thus, the number of passages p of the balls 13 can be obtained by using the displacement sensor 21B. The contact angle α of the ball 13 can be obtained from the number of passages p.

### EXAMPLES

An example in which the contact angle of the ball in the wheel bearing device is actually acquired using the method for acquiring the contact angle described above will be described.

The specification data of the ball of the wheel bearing device used to acquire the contact angle is as follows.

Diameter Dw: 23.8 (mm)

Pitch circle diameter Dpw: 50 (mm)

Number n: 20 (balls)

Then, the inner shaft of the wheel bearing device is rotated, and the number of rotation fr of the inner shaft is obtained by the processing device using the detection result of the rotation detection sensor. The number of passages p of rolling elements is obtained by the processing device using the detection result of the deformation detection sensor. As a result, the following values were obtained.

Rotation speed fr of inner shaft: 10 (rotations)

Number of passages p of balls p: 65 (times)

Then, the contact angle α is obtained by the processing device using the number of rotation fr of the inner shaft, the number of passages p of the balls, and the abovementioned specification data Dw, Dpw, and n of the ball. As a result, the contact angle α has the following value.

Contact angle α: 42.7 (deg)

From the above, it has been found that the contact angle of the ball can be appropriately acquired by using the detection results of the rotation detection sensor 22 and the deformation detection sensor 32 and the specification data of the ball.

The embodiments of the first invention disclosed herein are illustrative in all respects and are not restrictive. The scope of rights of the present invention is not limited to the abovementioned embodiments, and includes all modifications within the scope equivalent to the configuration described in the claims.

The contact angle α may be acquired only for the ball 13 in one row of the double rows. There is a correlation between the contact angle of the ball 13 in one row and the contact angle of the ball in the other row. Therefore, the contact angle of the ball in the other row may be obtained from the acquired contact angle of the ball in one row.

The rotation detection sensor 22 is not limited to directly detect the number of rotation of the inner shaft 12, and may indirectly detect the number of rotation. For example, the number of rotation of a motor that rotates the inner shaft 12 may be detected.

The deformation detection sensor 21 is not limited to the strain gauge 21A or the displacement sensor 21B, and any sensor may be used as long as it can detect deformation of the outer ring 11 (bearing ring).

The present invention can also be applied to an angular contact ball bearing other than the wheel bearing device.

In the angular contact ball bearing, the inner ring may be fixed, and the outer ring may rotate. In this case, the deformation detection sensor 21 can be provided to the inner ring.

(Second Invention)

### First Embodiment of Second Invention

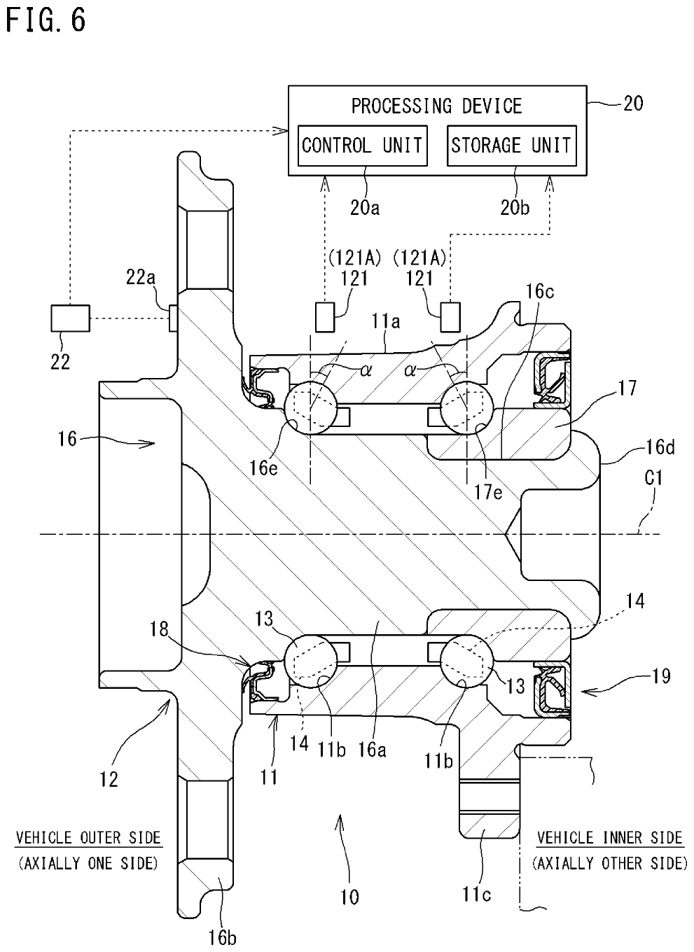

FIG. 6 is a cross-sectional view of an angular contact ball bearing used for a method for acquiring a contact angle according to a first embodiment. The angular contact ball bearing according to the present embodiment is a wheel bearing device (hub unit) 10 used for a vehicle such as an automobile.

The wheel bearing device 10 supports a wheel in a rotatable manner with respect to a suspension device provided to a body of the vehicle. The wheel bearing device 10 includes an outer ring 11, an inner shaft 12, balls 13, and cages 14. In the following description, a direction parallel to a central axis C1 of the wheel bearing device 10 (horizontal direction in FIG. 6) is referred to as an axial direction. In a state where the wheel bearing device 10 is mounted on the body of the vehicle, the left side in FIG. 6 which is the vehicle outer side is referred to as an axially one side, and the right side in FIG. 6 which is the vehicle inner side is referred to as an axially other side.

In the present disclosure, the central axis of the inner shaft 12 and the central axis of the outer ring 11 coincide with each other, and they are set as the central axis C1 of the wheel bearing device 10. A direction perpendicular to the central axis C1 is a radial direction.

The outer ring 11 and the inner shaft 12 are located concentrically. In the present embodiment, the inner shaft 12 is rotatable about the central axis C1 with respect to the outer ring 11. The wheel bearing device 10 rotatably supports the inner shaft 12 on which a wheel or a brake disk (not illustrated) is fixed to a flange part 16b with respect to the body.

The outer ring 11 is made of carbon steel for machine structural use, or the like. The outer ring 11 is formed into a cylindrical shape, and has a flange 11c on an outer peripheral surface 11a. The flange 11c is fixed to the suspension device, which is mounted on the vehicle body, with a bolt. A double-row outer raceway 11b is formed in the inner peripheral surface of the outer ring 11.

The inner shaft 12 is made of carbon steel for machine structural use, or the like. The inner shaft 12 constitutes an inner ring of the angular contact ball bearing. The inner shaft 12 includes a shaft member 16 and an inner-ring member 17.

The shaft member 16 has a main body part 16a extending along the axial direction and a flange part 16b protruding outward from the main body part 16a in the radial direction. The main body part 16a and the flange part 16b are integrally formed. The flange part 16b is provided on the axially one side of the main body part 16a. The flange part 16b is mounted with a wheel and a brake disk (not shown).

The inner-ring member 17 is annular, and fixed to an end part of the shaft member 16 on the axially other side. Specifically, the shaft member 16 has a small-diameter part 16c having an outer diameter smaller than that of other part of the main body part 16a on the axially other side. The inner-ring member 17 is engaged with the small-diameter part 16c. The inner-ring member 17 is fixed to the shaft member 16 by plastically deforming an end part 16d of the shaft member 16 on the axially other side outward in the radial direction and caulking the deformed end part 16d.

An inner raceway 16e is formed in the outer peripheral surface of the main body part 16a of the shaft member 16. The inner raceway 16e faces the outer raceway 11b located on the axially one side. An inner raceway 17e is formed in the outer peripheral surface of the inner-ring member 17. The inner raceway 17e faces the outer raceway 11b located on the axially other side.

Multiple first balls 13 are disposed between the first outer raceway 11b and the first inner raceway 16e on the axially one side. Multiple second balls 13 are disposed between the second outer raceway 11b and the second inner raceway 17e on the axially other side. The multiple balls 13 in each row are retained by cages 14 at intervals in the circumferential direction. Each of the outer raceway 11b and the inner raceways 16e and 17e has a cross-section with a concave arc shape. The first balls 13 are in point contact with each of the first outer raceway 11b and the first inner raceway 16e at a contact angle α. The second balls 13 are in point contact with each of the second outer raceway 11b and the second inner raceway 17e at the contact angle α. Thus, the wheel bearing device 10 is configured as a double-row angular contact ball bearing, and the outer ring 11 and the inner shaft 12 constitute respective bearing rings.

Sealing members 18 and 19 are attached between both end parts of the outer ring 11 in the axial direction and the inner shaft 12, more specifically, between the end part of the outer ring 11 on the axially one side and the main body part 16a and between the end part of the outer ring 11 on the axially other side and the inner-ring member 17, respectively. The sealing members 18 and 19 function to prevent intrusion of foreign matters such as muddy water into an annular space formed between the outer ring 11 and the inner shaft 12 and sealing the annular space so as to prevent a leakage of lubricant in the annular space.

In the wheel bearing device 10 having the above configuration, the contact angles α of the balls 13 with respect to the outer raceway 11b and the inner raceways 16e and 17e affect the rigidity and rotational torque of the wheel bearing device 10. Therefore, it is required to set the contact angles α to an appropriate value determined by design. However, it is difficult to directly measure the contact angle α of each ball 13 arranged inside the wheel bearing device 10. Therefore, the wheel bearing device 10 is assembled so that the contact angles α have an appropriate value by controlling a load applied for caulking and fixing the inner-ring member 17 to the shaft member 16.

However, each component constituting the wheel bearing device 10 has a dimensional error or the like. Therefore, the contact angles α of the balls 13 are likely to vary only by controlling the load applied for caulking and fixing. As a result, it is difficult to maintain a constant level of quality of the wheel bearing device 10 as a product.

In view of this, the present embodiment aims to improve the quality of the wheel bearing device 10 by enabling acquisition of the contact angle α of each ball 13 even in the assembled wheel bearing device 10.

[Method for Acquiring Contact Angle]

A specific method for acquiring the contact angle will be described below.

As illustrated in FIG. 6, in the present embodiment, the inner shaft 12 of the wheel bearing device 10 in an assembled state is rotated as one step of a quality inspection. The displacement (deformation) of the outer ring 11 at that time is detected by a sensor 121, and the contact angle α of the ball 13 is obtained by the processing device 20 using the detection result. That is, the method for acquiring the contact angle according to the present embodiment includes: a “detection step” of detecting the displacement of the outer ring 11; and a “calculation step” of obtaining the contact angle α of the ball 13 using the detection result of the detection step. The method for acquiring the contact angle according to the present embodiment further includes an “estimation step”, an “analysis step”, a “determination step”, and an “assessment step” in addition to the detection step and the calculation step. The method for acquiring the contact angle including the above steps will be specifically described below.

The processing device 20 includes, for example, a computer including a control unit 20a including a CPU and the like and a storage unit 20b including a storage such as an HDD, a volatile memory, and the like. The control unit 20a executes a computer program read from the storage unit 20b to perform processing of calculating the contact angle α of the ball 13.

As information for obtaining the contact angle α, the processing device 20 stores Equations (1) and (2) to be described later and parameters included in Equations (1) and (2) in the storage unit 20b.

Equation (1) is for obtaining the orbital number of rotation f of the ball 13.

$$\begin{matrix}[ Equation 1 ] & \\ f = \frac{1}{2} ( 1 - \frac{{D}_{w}}{{D}_{pw}} cos α ) {f}_{r} & ( 1 )\end{matrix}$$

In Equation 1, Dw is the diameter of the ball 13, and Dpw is the pitch circle diameter of the ball 13. The units of Dw and Dew are the same. α is a contact angle. fr is the number of rotation of the inner shaft 12 per unit time. The units off and fr are the same.

The orbital number of rotation f of the ball 13 can be expressed by Equation (2) below using the number n of the balls 13 and the number of times (the number of passages of the balls 13) p the balls 13 pass through a specific position of the outer ring 11 in the circumferential direction in a unit time (predetermined time).

f=p/n (2)

In Equations (1) and (2) above, the diameter Dw, the pitch circle diameter Dpw, and the number n, which are specification data pertaining to the balls 13, are known values and stored in the storage unit 20b.

In Equation (1), the number of rotation fr of the inner shaft 12 can be obtained by the processing device 20 from the detection result of the rotation detection sensor 22, for example. As the rotation detection sensor 22, an optical rotation detection sensor is used, for example. The optical rotation detection sensor irradiates the flange part 16b of the inner shaft 12 with light, and measures reflected light from a reflection plate 22a provided on the flange part 16b. The detection result of the rotation detection sensor 22 is transmitted to the processing device 20. The position detected by the rotation detection sensor 22 is not particularly limited as long as it periodically moves with the rotation of the inner shaft 12.

The number of rotation fr of the inner shaft 12 may be obtained from a driving number of rotation of a motor that rotates the inner shaft 12. The number of rotation fr of the inner shaft 12 may be obtained using frequency analysis of a detection result of the displacement detection sensor 121 described below.

(Detection Step)

In Equation (2), the number of passages p of the balls 13 is obtained using the detection result of the displacement detection sensor 121. The displacement detection sensor 121 is disposed so as to face the outer peripheral surface 11a of the outer ring 11. The displacement detection sensor 121 externally detects displacement (deformation) of the outer ring 11 associated with the orbital rotation of the ball 13 on the outer raceway 11b. In the present embodiment, this step is referred to as a “detection step”.

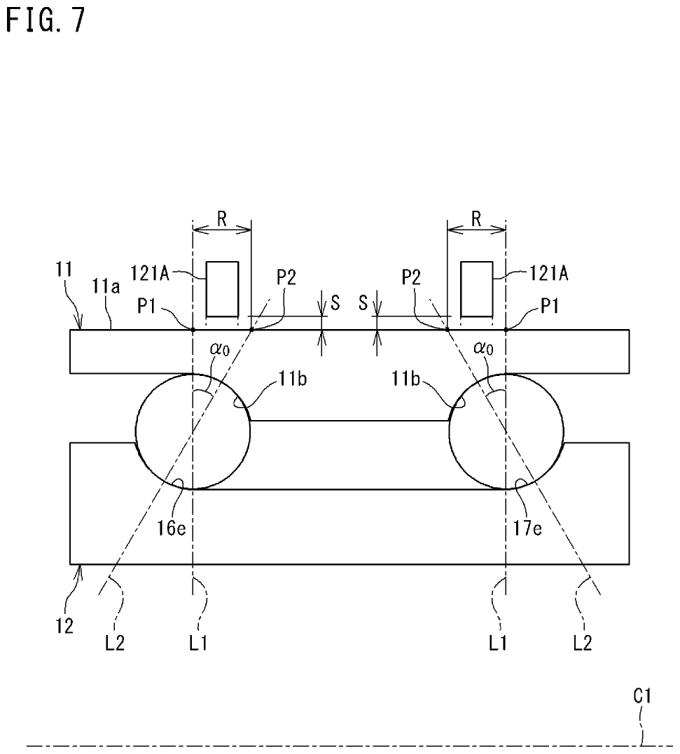

In the present embodiment, a capacitance displacement detection sensor 121A is used as the displacement detection sensor 121. The capacitance displacement detection sensor 121A is a non-contact sensor that does not contact the outer peripheral surface 11a of the outer ring 11. The displacement detection sensor 121A measures a change in a distance S (see FIG. 7) between the outer peripheral surface 11a of the outer ring 11 and the displacement detection sensor 121A. The detection result of the displacement detection sensor 121A is transmitted to the processing device 20.

FIG. 7 is an explanatory diagram illustrating the displacement sensor.

The displacement detection sensor 121A is provided to detect the displacement of the outer ring 11 within a region R illustrated in FIG. 7. In other words, the detection position of the displacement detection sensor 121A overlaps the region R. The region R is located between a first point P1 and a second point P2 on the outer peripheral surface 11a of the outer ring 11. The first point P1 is located on a straight line L1 that is perpendicular to the central axis C1 of the wheel bearing device 10 and passes through the center of the ball 13. The second point P2 is located on a straight line (straight line forming a design value α0 of the contact angle) L2 passing through the contact point between the outer raceway 11b and the ball 13 and the center of the ball 13. The region R is a portion where the outer ring 11 is relatively largely displaced by the rolling of the ball 13 on the outer raceway 11b. The displacement detection sensor 121A may be provided to detect displacement of the outer ring 11 in the entire region R, or may be provided to detect displacement in a part of the region R.

When the ball 13 rolls on the outer raceway 11b and passes immediately below the displacement detection sensor 121A, the outer ring 11 is pressed radially outward by the ball 13. Therefore, the elastic deformation of the outer ring 11 increases in the portion where the outer ring 11 faces the displacement detection sensor 121A. In addition, after the ball 13 passes immediately below the displacement detection sensor 121A, the outer ring 11 is not pressed radially outward by the ball 13. Therefore, the elastic deformation of the outer ring 11 is eliminated. The displacement detection sensor 121A outputs a signal corresponding to a change in the distance S due to such periodic elastic deformation (displacement) of the outer ring 11. The frequency of this signal corresponds to the number of passages p of the balls 13 per unit time.

The displacement detection sensor 121A also detects the displacement of the outer ring 11 due to a factor other than the rolling of the ball 13 on the outer raceway 11b. For example, the displacement detection sensor 121A detects displacement caused by runout (hereinafter, also referred to as “axial runout”) of the central axis of the inner shaft 12. In addition, the displacement detection sensor 121A also detects electrical or magnetic noise other than the displacement of the outer ring 11.

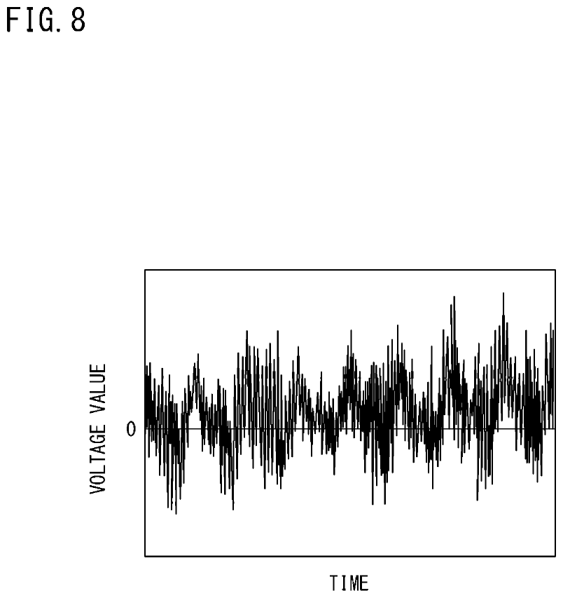

FIG. 8 is a graph illustrating a detection result of the displacement detection sensor 121A.

The horizontal axis of the graph represents time, and the vertical axis represents the output value (voltage value) of the displacement detection sensor 121A. As described above, the detection result of the displacement detection sensor 121A includes various factors such as the rolling of the ball 13 on the outer raceway 11b, axial runout of the inner shaft 12, and noise. Therefore, it is difficult to specify the frequency of the displacement of the outer ring 11 due to the rolling of the ball 13 on the outer raceway 11b from the graph illustrated in FIG. 8. Therefore, in the present embodiment, the processing device 20 executes the “estimation step”, the “analysis step”, and the “determination step” as described below. This makes it possible to easily specify the frequency of the displacement of the outer ring 11.

(Estimation Step)

The processing device 20 estimates the number of passages p of the balls 13 per unit time (for example, 1 second) by Equations (1) and (2) above using the design value α0 of the contact angle α instead of the contact angle α in the wheel bearing device 10 in the assembled state (estimation step). As described above, the number of passages p of the balls 13 corresponds to the number of times (frequency) of periodic displacement of the outer ring 11 due to rolling of the balls 13 on the outer raceway 11b. The processing device 20 sets a predetermined range A including the frequency (estimated value of the frequency) corresponding to the number of passages p of the balls 13 estimated from the design value α0 of the contact angle α. For example, when the estimated value of the frequency corresponding to the number of passages p of the balls 13 is defined as fp′, the range A is set using Equation (3) below.

A=fp′±B (3)

(where B is a predetermined constant)

The estimation step is performed before the detection step is performed. In this case, the number of rotation of the inner shaft 12 to be applied in the detection step is used as the number of rotation fr of the inner shaft 12 in Equation (1). The estimation step can also be performed after the detection step. In this case, as the number of rotation fr of the inner shaft 12, the number of rotation of the inner shaft 12 applied in the detection step (the number of rotation obtained from the detection result of the rotation detection sensor 22 or the driving number of rotation of the motor) can be used.

(Analysis Step and Determination Step)

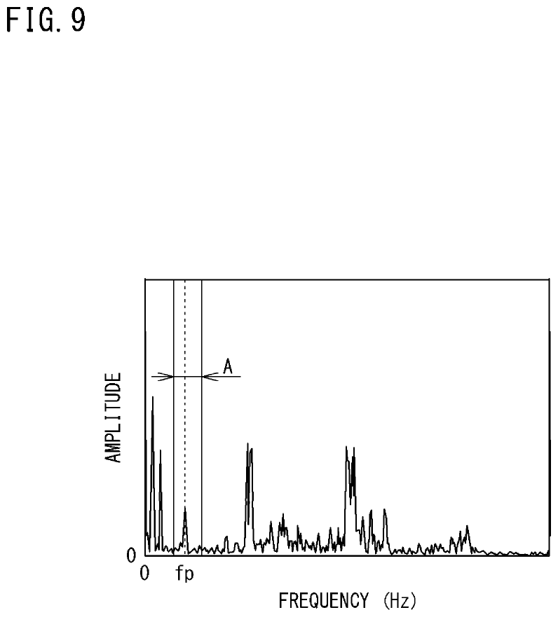

FIG. 9 is a graph obtained by performing frequency analysis on the detection result of the displacement detection sensor illustrated in FIG. 8. Specifically, FIG. 9 is a graph obtained by analyzing the detection result of the displacement detection sensor illustrated in FIG. 8 using fast Fourier transform (FFT).

The processing device 20 obtains the magnitude of the amplitude for each frequency as illustrated in FIG. 9 by performing frequency analysis on the detection result of the displacement detection sensor 121A (analysis step). Then, in the analysis result illustrated in FIG. 9, the processing device 20 determines the frequency having a peak within the range A which is set on the basis of the estimated value fp′ of the frequency as the frequency fp corresponding to the number of passages p of the balls 13 (determination step).

(Calculation Step)

The processing device 20 obtains the orbital number of rotation f of the ball 13 by dividing the number of passages p of the balls 13 (frequency fp) by the number n of the balls 13 using Equation (2). Then, the processing device 20 obtains the contact angle α of the ball 13 of the wheel bearing device 10 in an assembled state from the orbital number of rotation f of the ball 13, the number of rotation fr detected by the rotation detection sensor 22, etc., and the specification data Dw and Dpw of the ball 13 using Equation (1).

(Assessment Step)

The processing device 20 performs an assessment step of assessing whether or not the obtained contact angle α falls within an acceptable error range of the predetermined design value α0. If the contact angle α of the ball 13 thus obtained falls within the acceptable error range of the predetermined design value α0, the wheel bearing device 10 is considered to be a product that satisfies the predetermined quality. Therefore, it is possible to suppress a variation in quality of products by performing the assessment step. If the contact angle α is smaller than the acceptable error range of the predetermined design value α0, the contact angle α is increased by additionally performing a caulking process on the shaft member 16 of the inner shaft 12, and due to such process, predetermined quality can also be obtained.

The capacitance displacement detection sensor 121A detects displacement while not in contact with the outer peripheral surface 11a of the outer ring 11. Therefore, it is not necessary to incorporate the sensor in the outer ring 11, attach the sensor to the outer peripheral surface 11a of the outer ring 11 every time quality inspection is performed, or perform a pretreatment for smoothing the place where the sensor is to be attached.

The result of the frequency analysis illustrated in FIG. 9 may indicate that there are multiple frequency peaks within the range A. In such a case, only the frequency fp corresponding to the number of passages p of the balls 13 can be specified by, for example, the following method. For example, in the detection step, the displacement of the outer ring 11 is detected by the displacement detection sensor 121A in a state where the number of rotation fr of the inner shaft 12 is increased, and the detection result is subjected to frequency analysis. The frequency fp corresponding to the number of passages p of the balls 13 increases at a rate corresponding to the rate of increase in rotation of the inner shaft 12. On the other hand, other frequencies, for example, frequencies due to noise detected by the displacement detection sensor 121A do not change even if the number of rotation of the inner shaft 12 is increased. Therefore, the frequency fp corresponding to the number of passages p of the balls 13 can be specified from the frequencies due to a plurality of factors.

Instead of changing the number of rotation fr of the inner shaft 12, it is also possible to specify the frequency fp corresponding to the number of passages p of the balls 13 by adjusting the constant B in Equation (3) and narrowing the range A.

In the result of the frequency analysis illustrated in FIG. 9, a peak also appears at a frequency corresponding to the number of rotation fr of the inner shaft 12. Therefore, it is also possible to obtain the number of rotation fr of the inner shaft 12 using the frequency result illustrated in FIG. 9. In this case, the rotation detection sensor 22 as described above is unnecessary, and the displacement detection sensor 121 can also be used as the rotation detection sensor of the inner shaft 12.

### Second Embodiment of Second Invention

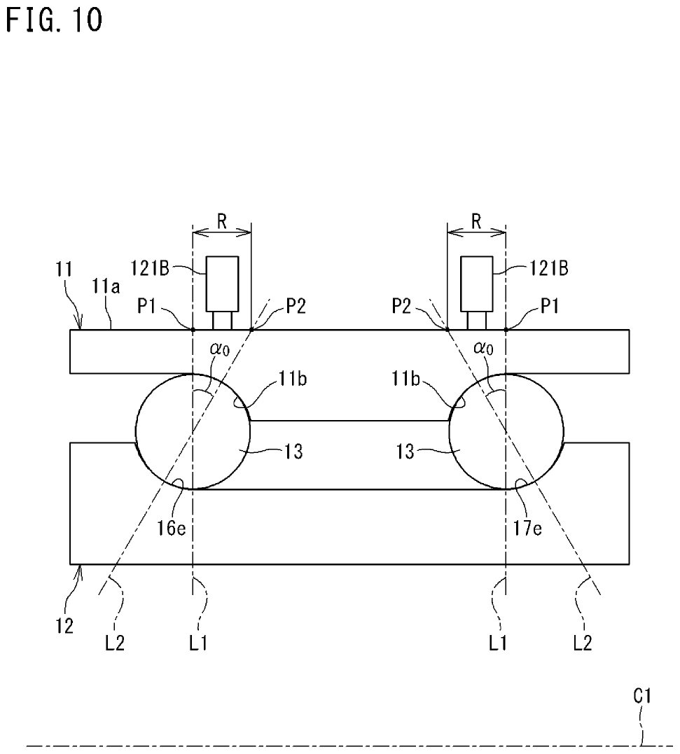

FIG. 10 is an explanatory diagram illustrating a displacement detection sensor used for a method for acquiring a contact angle according to a second embodiment.

In the embodiment described above (see FIG. 7), the capacitance displacement detection sensor 121A is used as the displacement detection sensor. In the second embodiment, an acceleration sensor 121B is used as the displacement detection sensor. The acceleration sensor 121B is a contact sensor that is in contact with the outer peripheral surface 11a of the outer ring 11. The acceleration sensor 121B detects the displacement of the outer ring 11 in the radial direction in the region R. In addition, the acceleration sensor 121B is detachably attached to the outer peripheral surface 11a of the outer ring 11 by a magnet, an adhesive, or the like.

When the ball 13 passes immediately below the acceleration sensor 121B, the outer peripheral surface 11a of the outer ring 11 is displaced so as to slightly expand radially outward, and after the ball 13 passes immediately below the acceleration sensor 121B, the outer peripheral surface 11a of the outer ring 11 is displaced so as to relatively shrink radially inward. The acceleration sensor 121B detects such displacement (substantially, the acceleration of the displacement) of the outer peripheral surface 11a of the outer ring 11 in the radial direction. Therefore, the contact angle α of the ball 13 can be obtained by performing the analysis step as described above using the detection result of the acceleration sensor 121B, and determining the frequency fp corresponding to the number of passages p of the balls 13 on the basis of the frequency estimated in the estimation step.

The acceleration sensor 121B is detachably mounted to the outer peripheral surface 11a of the outer ring 11. Therefore, it is not necessary to incorporate the sensor in the outer ring 11, and the sensor may be attached to the outer peripheral surface 11a of the outer ring 11 only when the contact angle α of the ball 13 is obtained (when the inspection process is performed).

The embodiments of the second invention disclosed herein are illustrative in all respects and are not restrictive. The scope of rights of the present invention is not limited to the abovementioned embodiments, and includes all modifications within the scope equivalent to the configuration described in the claims.

The contact angle α may be acquired only for the ball 13 in one row of the double rows. There is a correlation between the contact angle of the ball 13 in one row and the contact angle of the ball in the other row. Therefore, the contact angle of the ball in the other row may be obtained from the acquired contact angle of the ball in one row.

The displacement detection sensor 121 is not limited to the capacitance displacement detection sensor 121A and the acceleration sensor 121B, and is not particularly limited as long as it can detect the displacement (deformation) of the outer ring 11. As the non-contact type displacement detection sensor 121 described in the first embodiment, a laser displacement detection sensor or an eddy-current displacement detection sensor can be used. A strain gauge can also be used as the contact-type displacement (deformation) detection sensor 121 described in the second embodiment.

The method for acquiring the contact angle α is not limited to be performed after the assembly of the wheel bearing device 10, and can be performed in parallel with the assembly step (manufacturing step) of the wheel bearing device 10.

The present disclosure can also be applied to an angular contact ball bearing other than the wheel bearing device.

[First Invention and Second Invention Described Above]

Each step of the second invention is applicable to the first invention, and a relationship between the steps of the first invention and the steps of the second invention is as follows.

The first detection step of the first invention includes the following steps of the second invention.
a step of detecting the number of rotation of the inner shaft 12 (first bearing ring, rotating ring) of the wheel bearing device (angular contact ball bearing)
an estimation step of obtaining an estimated value of the frequency of periodic displacement of the outer ring 11 (second bearing ring, stationary ring) associated with the orbital rotation of the ball 13 when the inner shaft 12 is rotated, using the detected number of rotation of the inner shaft 12, the specification data pertaining to the ball 13, and the design value α0 of the contact angle of the ball 13.

In the second detection step of the first invention, the displacement of the outer ring 11 is detected, as the deformation of the outer ring 11, from the outside by the sensor in a state where the inner shaft 12 is rotated, as described in the second invention.

The calculation step of the first invention includes the following steps of the second invention.
an analysis step of performing frequency analysis on a detection result of the second detection step
a determination step of determining the frequency of the displacement of the outer ring 11 from the analysis result in the analysis step on the basis of the estimated value obtained in the estimation step
a calculation step of obtaining the contact angle α of the ball 13 using the frequency determined in the determination step, the number of rotation of the inner shaft 12, and the specification data pertaining to the ball 13

Further, the first invention including the steps of the second invention further includes the following assessment step.
Assessment step: a step of assessing whether or not the contact angle α obtained in the calculation step falls within an acceptable error range of a design value of the contact angle

Note that the invention of the present disclosure may have a configuration obtained by freely combining at least some of the embodiments described with respect to the first invention and the second invention.

[Method for Manufacturing Wheel Bearing Device]

The method for acquiring the contact angle α described in the embodiments of each of the first invention and the second invention can be included in a method for manufacturing the wheel bearing device 10.

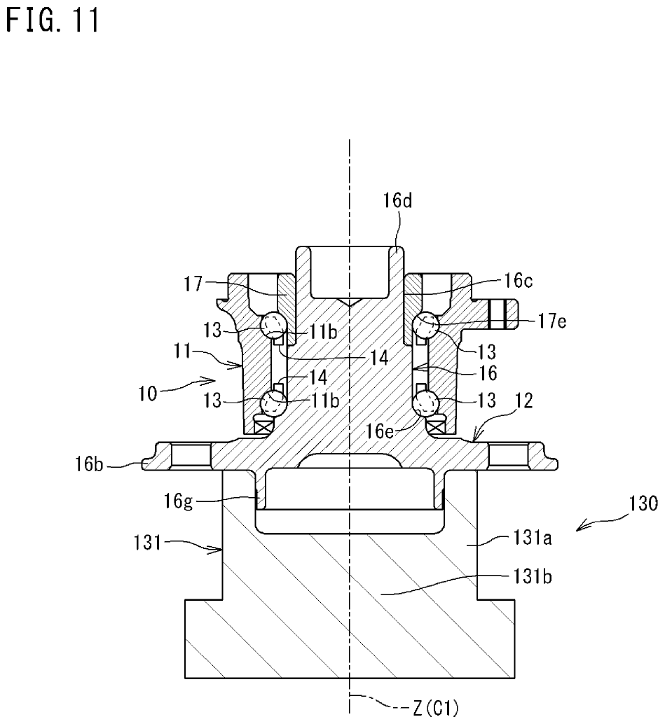

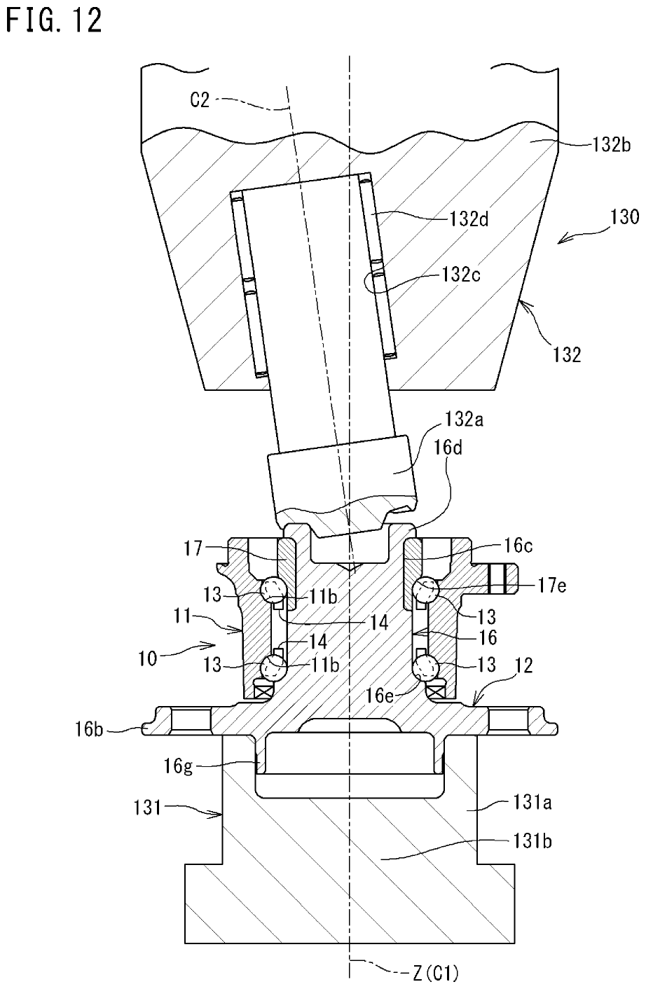

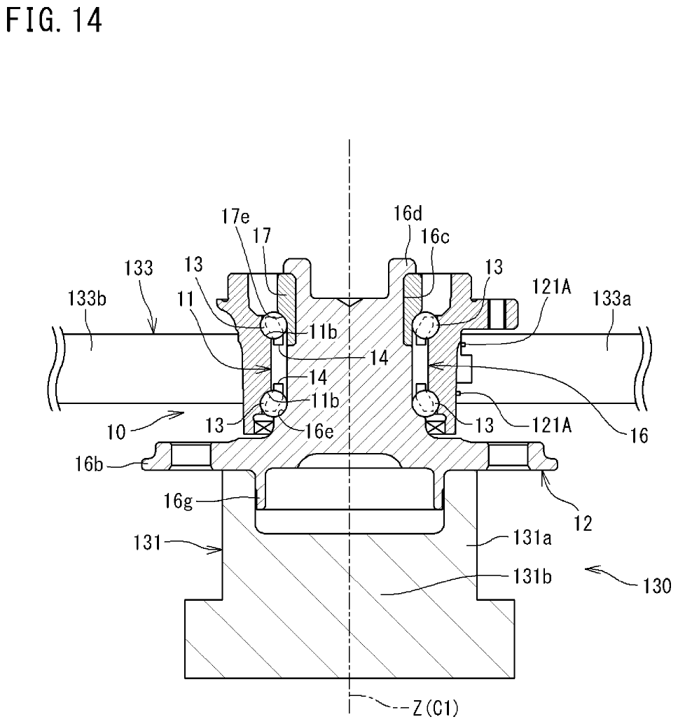

As described above, the manufacturing device 30 illustrated in FIG. 4 is used in the method for manufacturing the wheel bearing device 10. FIGS. 11, 12, 13, and 14 illustrate a modification of the manufacturing device 30 illustrated in FIG. 4. Similar to the manufacturing device 30 illustrated in FIG. 4, a manufacturing device 130 illustrated in FIGS. 11 to 14 is for fixing the inner-ring member 17 to the shaft member 16 by caulking the end part 16d of the shaft member 16 of the inner shaft 12 on the axially other side. As illustrated in FIG. 12, the manufacturing device 130 includes an inner-ring holding jig 131 and a caulking apparatus 132. As illustrated in FIG. 14, the manufacturing device 130 further includes an outer-ring holding jig 133. The outer-ring holding jig 133 has a first outer-ring holding jig piece 133a and a second outer-ring holding jig piece 133b obtained by dividing the outer-ring holding jig 133 into two.

As illustrated in FIG. 11, the inner-ring holding jig 131 includes a jig body 131b and an annular placement part 131a protruding upward in the vertical direction from the jig body 131b. The central axis of the placement part 13a coincides with a reference axis (reference line) Z of the manufacturing device 130, and the reference axis Z is along the vertical line in the present disclosure. The inner-ring holding jig 131 is rotatable about the central axis (reference axis Z) and is supported by a main body (not shown) of the manufacturing device. The manufacturing device 130 includes a motor that rotates the inner-ring holding jig 131, a speed reducer, and a brake that brakes and immobilizes the inner-ring holding jig 131 so that the inner-ring holding jig 131 cannot rotate. These components are not illustrated.

As illustrated in FIG. 12, the caulking apparatus 132 includes a punch 132a and a rotary spindle 132b. The rotary spindle 132b is a columnar member centered on the reference axis Z of the manufacturing device 130. The rotary spindle 132b is held by a lifting frame (not illustrated) so as to be rotatable about the reference axis Z, and is movable in the vertical direction. A hole 132c opened downward is formed in the rotary spindle 132b. A central axis (center line) C2 of the hole 132c is inclined at a predetermined angle with respect to the reference axis Z. The punch 132a is a shaft-shaped member, and is provided in a rotatable manner inside the hole 132c via a bearing part 132d.

A method for manufacturing the wheel bearing device 10 using the manufacturing device 130 is as follows.

In order to manufacture the wheel bearing device 10, the shaft member 16 is placed on the placement part 131a of the inner-ring holding jig 131 in the mode shown in FIG. 11. At this time, the flange part 16b is directed downward, and a cylindrical portion 16g protruding from the flange part 16b is placed on the inner peripheral side of the placement part 131a. The axially one side which is the vehicle outer side of the wheel bearing device 10 is on the lower side, and the axially other side which is the vehicle inner side is on the upper side.

The plurality of balls 13 housed in pockets of the cages 14 is placed on the inner raceway 16e of the shaft member 16 on the axially one side. The outer ring 11 is attached to the shaft member 16 such that the outer raceway 11b of the outer ring 11 on the axially one side is placed on the balls 13. Further, the plurality of balls 13 housed in pockets of the cages 14 is placed on the outer raceway 11b of the outer ring 11 on the axially other side, and the inner-ring member 17 is engaged with the small-diameter part 16c of the shaft member 16 such that the inner raceway 17e is placed on the balls 13. As a result, a wheel bearing device in which the end 16d is not yet caulked as illustrated in FIG. 11 is obtained. The central axis C1 of the wheel bearing device coincides with the reference axis Z.

The inner-ring holding jig 131 is held by the brake so as not to rotate with respect to the main body (not illustrated) of the manufacturing device.

The rotary spindle 132b (see FIG. 12) rotates about the reference axis Z by an electric motor (not illustrated). The rotary spindle 132b is lowered while being rotated. As a result, the punch 132a presses the end part 16d of the shaft member 16 on the axially other side, and revolves, while axially rotated, by the rotation of the rotary spindle 132b in a state of being inclined with respect to the reference axis Z. Thus, the punch 132a moves along the circumferential direction on the end surface of the end part 16d, and plastically deforms the end part 16d radially outward and caulks the deformed end part 16d. Accordingly, the inner-ring member 17 is fixed to the shaft member 16 on the axially other side so as not to drop (see FIG. 12).

As described above, in the method for manufacturing the wheel bearing device according to the present disclosure, an assembly step including the following steps is performed.
a step of placing the plurality of first balls 13 on the first inner raceway 16e of the shaft body 16
a step of assembling the shaft member 16 and the outer ring 11 together such that the first outer raceway 11b of the outer ring 11 is placed on the first balls 13
a step of engaging the inner-ring member 17 with the small-diameter part 16c such that the plurality of second balls 13 is placed on the second outer raceway 11b of the outer ring 11 and the second inner raceway 17e of the inner-ring member 17 is placed on the second balls 13
a fixing step of fixing the inner-ring member 17 to the shaft member 16 by plastically deforming the end part 16d of the shaft member 16 on the axially other side outward in the radial direction and caulking the deformed end part 16d

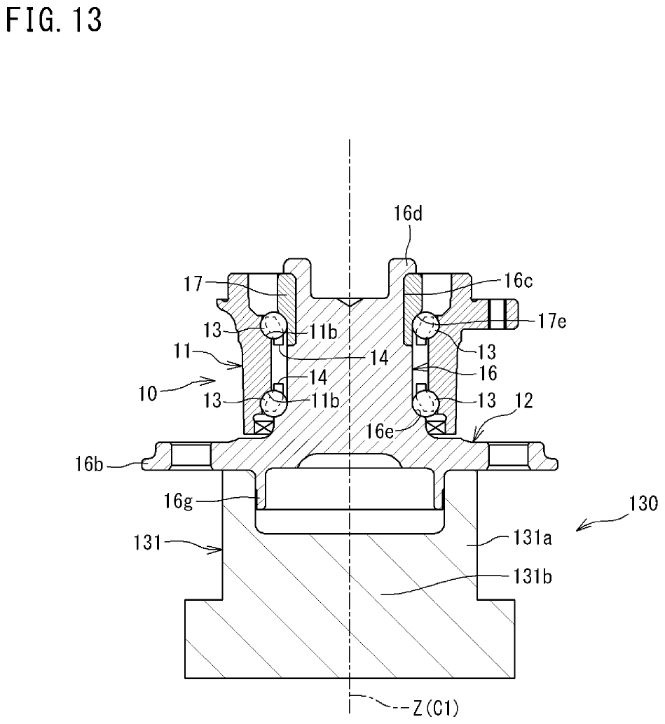

After the caulking (caulking process) in the fixing step is completed, the rotary spindle 132b is retracted upward (see FIG. 13).

As illustrated in FIG. 14, the first outer-ring holding jig piece 133a and the second outer-ring holding jig piece 133b hold the outer ring 11 from two places located on the outside of the outer ring 11 in the radial direction and separated from each other by 180°. As a result, the outer ring 11 is held so as not to rotate.

A sensor that detects deformation (displacement) of the outer ring 11 is attached to the inner peripheral surface of the first outer-ring holding jig 133a. Specifically, the first sensor 121A is attached to the inner peripheral surface of the first outer-ring holding jig 133a on the axially one side, and the second sensor 121A is attached to the inner peripheral surface on the axially other side.

Since the first outer-ring holding jig piece 133a and the second outer-ring holding jig piece 133b hold the outer ring 11, the sensor 121A on the axially one side and the sensor 121A on the axially other side face the outer peripheral surface 11a in the region in the axial direction between the first point P1 (annular circle centered on the central axis C1 passing through the point P1) on the outer peripheral surface 11a of the outer ring 11 and the second point P2 (annular circle centered on the central axis C1 passing through the point P2) on the outer peripheral surface 11a as illustrated in FIG. 7.

The brake is released, so that the inner shaft 11 and the inner-ring holding jig 131 are rotatable, and the inner-ring holding jig 131 is rotated by the motor (see FIG. 9). Thus, the inner shaft 12 rotates about the central axis C1 (reference axis Z). At this time, the sensor 121A, which is a non-contact sensor, obtains the contact angle α by the acquisition method of each mode described above. Note that the sensor that detects deformation (displacement) of the outer ring 11 is not limited to the sensor 121A, and the acceleration sensor 121B may be used, for example.

As described above, the method for manufacturing the wheel bearing device according to the present disclosure includes the following contact angle acquisition step.
Contact angle acquisition step: a step of obtaining the contact angle α in a state where the wheel bearing device is assembled through the assembly step

The method for obtaining the contact angle α in the contact angle acquisition step is the contact angle acquisition method of each mode described above.

The contact angle acquisition step may be performed in parallel with the fixing step included in the assembly step. That is, the acquisition of the contact angle α performed in parallel with the fixing step includes acquiring the contact angle α simultaneously with the caulking process of the shaft member 16 and alternately performing acquisition of the contact angle α of the ball 13 and the caulking process of the shaft member 16. In the former case, while the shaft member 16 is caulked, the contact angle α of the ball 13 is simultaneously acquired and checked, and when the contact angle α reaches an appropriate value, the caulking process is terminated. In the latter case, the caulking process is intermittently performed while the contact angle α is checked. Specifically, for example, after the shaft member 16 is caulked halfway, the contact angle α of the ball 13 is temporarily acquired and checked, and then, the caulking process is started again.

Then, it is determined whether or not the contact angle α is included in the allowable value (design range). A product having a contact angle α which is included in the allowable value range is determined to be satisfactory, and such product is subjected to the next process.

In the above manufacturing method, the shaft member 16, the balls 13 in two rows, and the outer ring 11 are assembled on the inner-ring holding jig 131 to assemble the wheel bearing device to which the caulking process is not yet performed as shown in FIG. 11. However, the wheel bearing device to which the caulking process is not yet performed may be assembled in a region different from the manufacturing device 130 (30), such as a jig different from the inner-ring holding jig 131. In this case, the assembled wheel bearing device to which the caulking process is not yet performed is placed on the inner-ring holding jig 131. Then, the caulking process (the fixing step) is performed by the manufacturing device 130 (30) in the same manner as described above. Then, the contact angle α is acquired.

### REFERENCE SIGNS LIST

10: WHEEL BEARING DEVICE
11: OUTER RING
11a: OUTER PERIPHERAL SURFACE
11b: OUTER RACEWAY (RACEWAY)
12: INNER SHAFT (INNER RING)
13: BALL
16: SHAFT MEMBER
16d: END PART
16e: INNER RACEWAY
17: INNER-RING MEMBER
17e: INNER RACEWAY
20: PROCESSING DEVICE
21: DEFORMATION DETECTION SENSOR
21A: STRAIN GAUGE
21B: DISPLACEMENT SENSOR
22: ROTATION DETECTION SENSOR
121: DISPLACEMENT DETECTION SENSOR
121A: CAPACITANCE DISPLACEMENT DETECTION SENSOR
121B: ACCELERATION SENSOR
A: RANGE
Dpw: PITCH CIRCLE DIAMETER
Dw: DIAMETER
n: NUMBER OF BALLS
P1: FIRST POINT
P2: SECOND POINT
fp: FREQUENCY OF DISPLACEMENT
fp′: ESTIMATED VALUE OF FREQUENCY OF DISPLACEMENT
fr: NUMBER OF ROTATION OF INNER SHAFT
R: REGION
α: CONTACT ANGLE
α0: DESIGN VALUE OF CONTACT ANGLE OF BALL

1. A method for acquiring a contact angle of an angular contact ball bearing, the method comprising:
a first detection step of detecting a number of rotation of a first bearing ring of an angular contact ball bearing;
a second detection step of externally detecting deformation of a second bearing ring associated with orbital rotation of a ball of the angular contact ball bearing; and
a calculation step of obtaining a contact angle of the ball using a detection result of the first detection step, a detection result of the second detection step, and specification data pertaining to the ball.

2. The method for acquiring a contact angle of an angular contact ball bearing according to claim 1, wherein the deformation of the second bearing ring is detected by a strain gauge in the second detection step.

3. The method for acquiring a contact angle of an angular contact ball bearing according to claim 1, wherein the deformation of the second bearing ring is detected by a displacement sensor in the second detection step.

4. The method for acquiring a contact angle of an angular contact ball bearing according to claim 1, wherein a detection position of the deformation of the second bearing ring is located within a region between a first point and a second point on a circumferential surface of the second bearing ring opposite to a surface in which the raceway of the ball is formed,
the first point being on a straight line that is perpendicular to an axis of the angular contact ball bearing and that passes through a center of the ball, and
the second point being on a straight line that passes through a contact point between a raceway of the second bearing ring and the ball and the center of the ball.

5. The method for acquiring a contact angle of an angular contact ball bearing according to claim 1, wherein the angular contact ball bearing is a wheel bearing device that includes: an outer ring having a double-row outer raceway; an inner shaft having a double-row inner raceway; and balls that are placed between the outer raceway and the inner raceway and that are in contact with the respective raceways at a contact angle, the inner shaft including a shaft member that has an inner raceway on an axially one side and an inner-ring member that has an inner raceway on an axially other side and that is caulked and fixed to the shaft member.

6. The method for acquiring a contact angle of an angular contact ball bearing according to claim 5, wherein the first detection step, the second detection step, and the calculation step are performed in parallel with an assembly step of the wheel bearing device.

7. The method for acquiring a contact angle of an angular contact ball bearing according to claim 1, wherein
the first detection step includes
a step of detecting a number of rotation of the first bearing ring of the angular contact ball bearing, and
an estimation step of obtaining, using the detected number of rotation of the first bearing ring, the specification data pertaining to the ball, and a design value of the contact angle of the ball, an estimated value of a frequency of periodic displacement of the second bearing ring associated with the orbital rotation of the ball when the first bearing ring is rotated,
in the second detection step, displacement of the second bearing ring is externally detected by a sensor as the deformation of the second bearing ring with the first bearing ring being rotated, and
the calculation step includes
an analysis step of performing a frequency analysis on a detection result of the second detection step,
a determination step of determining the frequency of the displacement of the second bearing ring from an analysis result of the analysis step on the basis of the estimated value obtained in the estimation step, and
a calculation step of obtaining the contact angle of the ball using the frequency determined in the determination step, the number of rotation of the first bearing ring, and the specification data pertaining to the ball.

8. The method for acquiring a contact angle of an angular contact ball bearing according to claim 7, further comprising an assessment step of assessing whether or not the contact angle obtained in the calculation step falls within an acceptable error range of the design value of the contact angle.

9. A method for acquiring a contact angle of an angular contact ball bearing that includes an outer ring, an inner ring disposed inside of the outer ring in a radial direction, and a plurality of balls placed between the outer ring and the inner ring, the method comprising:
an estimation step of obtaining, using a number of rotation of the inner ring, specification data pertaining to the balls, and a design value of a contact angle of each of the balls, an estimated value of a frequency of periodic displacement of the outer ring associated with orbital rotation of the balls when the inner ring is rotated;
a detection step of externally detecting the displacement of the outer ring by a sensor with the inner ring being rotated;
an analysis step of performing a frequency analysis on a detection result of the detection step;
a determination step of determining the frequency of the displacement of the outer ring from an analysis result of the analysis step on the basis of the estimated value obtained in the estimation step; and
a calculation step of obtaining the contact angle of each of the balls using the frequency determined in the determination step, the number of rotation of the inner ring, and the specification data pertaining to the balls.

10. The method for acquiring a contact angle of an angular contact ball bearing according to claim 9, wherein the sensor is a non-contact sensor.

11. The method for acquiring a contact angle of an angular contact ball bearing according to claim 9, wherein the sensor is a contact sensor, and is detachably mounted to the outer ring.

12. The method for acquiring a contact angle of an angular contact ball bearing according to claim 9, wherein a region where the sensor detects the displacement of the outer ring at least partially overlaps a region between a first point and a second point on an outer surface of the outer ring,
the first point being on a straight line that is perpendicular to a central axis of the angular contact ball bearing and that passes through a center of the ball, and
the second point being on a straight line that passes through a contact point between a raceway of the outer ring and the ball and the center of the ball.

13. The method for acquiring a contact angle of an angular contact ball bearing according to claim 9, further comprising an assessment step of assessing whether or not the contact angle obtained in the calculation step falls within an acceptable error range of the design value of the contact angle.

14. A method for manufacturing a wheel bearing device that is an angular contact ball bearing,
the wheel bearing device including
an outer ring having a first outer raceway and a second outer raceway formed in an inner peripheral surface on an axially one side and an axially other side,
an inner shaft including a shaft member that has a first inner raceway formed in an outer peripheral surface, and an inner-ring member that is engaged with a small-diameter part of the shaft member on the axially other side, the inner-ring member having a second inner raceway formed in an outer peripheral surface,
a plurality of first balls that is in contact with the first outer raceway and the first inner raceway at a contact angle, and
a plurality of second balls that is in contact with the second outer raceway and the second inner raceway at the contact angle,
the method comprising:
an assembly step including a step of placing the plurality of first balls on the first inner raceway, a step of assembling the shaft member and the outer ring together such that the first outer raceway is placed on the plurality of first balls, a step of placing the plurality of second balls on the second outer raceway and engaging the inner-ring member with the small-diameter part such that the second inner raceway of the inner-ring member is placed on the plurality of second balls, and a fixing step of fixing the inner-ring member to the shaft member by plastically deforming an end part of the shaft member on the axially other side outward in a radial direction and caulking the deformed end part; and
a contact angle acquisition step of obtaining the contact angle in a state where the wheel bearing device is assembled through the assembly step or in parallel with the fixing step, wherein
the method for acquiring a contact angle of an angular contact ball bearing according to claim 1 is used as a method for obtaining the contact angle in the contact angle acquisition step.

15. A method for manufacturing a wheel bearing device that is an angular contact ball bearing,
the wheel bearing device including
an outer ring having a first outer raceway and a second outer raceway formed in an inner peripheral surface on an axially one side and an axially other side,
an inner shaft including a shaft member that has a first inner raceway formed in an outer peripheral surface, and an inner-ring member that is engaged with a small-diameter part of the shaft member on the axially other side, the inner-ring member having a second inner raceway formed in an outer peripheral surface,
a plurality of first balls that is in contact with the first outer raceway and the first inner raceway at a contact angle, and
a plurality of second balls that is in contact with the second outer raceway and the second inner raceway at the contact angle,
the method comprising:
an assembly step including a step of placing the plurality of first balls on the first inner raceway, a step of assembling the shaft member and the outer ring together such that the first outer raceway is placed on the plurality of first balls, a step of placing the plurality of second balls on the second outer raceway and engaging the inner-ring member with the small-diameter part such that the second inner raceway of the inner-ring member is placed on the plurality of second balls, and a fixing step of fixing the inner-ring member to the shaft member by plastically deforming an end part of the shaft member on the axially other side outward in a radial direction and caulking the deformed end part; and
a contact angle acquisition step of obtaining the contact angle in a state where the wheel bearing device is assembled through the assembly step or in parallel with the fixing step, wherein
the method for acquiring a contact angle of an angular contact ball bearing according to claim 9 is used as a method for obtaining the contact angle in the contact angle acquisition step.
